(19) United States
(12) Patent Application Publication
(10) Pub. No.: US 2007/0248497 A1
(43) Pub. Date: Oct. 25, 2007

(54) MICROFLUIDIC DEVICE

(75) Inventor: Cedric Emile Francois ROBILLOT, Chuwa, Queensland (AU)

Correspondence Address: HOGAN & HARTSON L.L.P., 1999 AVENUE OF THE STARS, SUITE 1400, LOS ANGELES, CA, 90067, US

(73) Assignee: CLEVELAND BIOSENSORS PTY LTD, Eight Miles Plain (AU)

(21) Appl. No.: 11/570,126

(22) PCT Filed: Sep. 2, 2005
(86) PCT No.: PCT/AU05/01341

§ 371 Date: Dec. 6, 2006

(30) Foreign Application Priority Data
Sep. 28, 2004 (AU) 2004905578
Oct. 12, 2004 (AU) 2004905872
Apr. 7, 2005 (AU) 2005901714

(51) Int. Cl. B01L 3/00

(52) U.S. Cl. 422/100

(57) ABSTRACT

A closed loop microfluidic device that has at least one microchannel formed in a body and a pump in fluid connection with the microchannel. The pump is actuated by an external motive force to push and pull fluid through the microchannel. A number of chambers are formed in fluid connection with the microchannel to store reagents. The reagents are moved through the microchannel by the pump. A number of active zones are also formed in the microchannel. Various reactions and diagnostics are performed at the active zone. A sample is introduced to the microchannel through a sealable input port. The microchannel forms a closed loop with all necessary reagents and diagnostics contained within the closed loop microfluidic device. The sample is processed and analysed completely within the closed loop microchannel.

This invention relates to a microfluidic device. In particular, it relates to a closed loop device incorporating one or more pumps for moving fluid samples around the loop. The device finds particular application for compact bioassay chips.

### BACKGROUND TO THE INVENTION

Recent developments in bioassay device design have focussed on microfluidics, that is, the movement of small volumes of sample and reagents around microchannels. One such devices is described in United States patent application No. 2004/0132218, in the name of Ho. Ho describes a complex bioassay chip design that has multiple reaction wells and multiple sealed reagent cavities. The biochip operates with a microcap device that punctures the seal of the reagent cavity to release reagent to the reaction well. The Ho device does not allow for micropumping and therefore is limited to fairly simple applications.

The system described by Kuo in United States patent application No. 2003/0233827 is much simpler in terms of the number of possible reagents but incorporates a diaphragm micropump and is therefore able to move samples and reagents between zones on the microchip. Like many microchip systems, Kuo has difficulty moving fluids around the chip due to formation of vacuums behind the moving fluid. For his reason Kuo has a partially open system. Open systems are not appropriate for most bioassay applications, particularly applications which are intended for long term storage or which involve dangerous assays (carcinogens, etc).

The most comprehensive description of a (possibly) workable system is described by Singh in a family of patents including United States patent application No. 2002/0098122 and International patent application number WO 02/057744. Singh describes a disposable microfluidic biochip that is loaded with a sample and placed in a reader. The biochip has multiple check valves and diaphragm pumps that are magnetically actuated by electromagnets in the reader. By using static electromagnets and check valves Singh limits the versatility of the biochip.

An effective form of pumping is described by Kamholz in U.S. Pat. Nos. 6,408,884 and 6,415,821, and the various references listed therein. Kamholz describes a ferrofluidic pump that uses magnetic fields to move slugs of ferrogel along microchannels to move fluids ahead of and behind the slugs. Kamholz only discloses devices that have at least one fluid inlet and at least one fluid outlet so that fluid flows through the device. Kamholz does not disclose a closed loop device.

United States patent application number 5096669 assigned to I-Stat Corporation describes a system for fluid analysis using a hand-held reader and disposable microchip. The microchip uses capillary action to draw a sample into the chip and a depressible air bladder to cause the sample to flow over sensors. The I-Stat device is not a closed device and is not suitable for long term storage. The design only allows for simple movement of fluid.

Another design is described in international application number WO 2003/035229, assigned to NTU Ventures Pte Ltd. The NTU device is of the flow-through type rather than a closed loop design. There are a number of inlets and outlets for addition and removal of sample, buffer, flow promoting fluid, etc. The NTU device requires continuing user interaction to perform a diagnostic test, even if some of the reagents are pre-stored on the device. The device also requires an arrangement of valves to prevent flow into unwanted channels and chambers.

A patent application assigned to Motorola Inc, United States application No. 2005/0009101, describes a microfluidic device loaded with multiple capture binding ligand sites. The Motorola patent application describes using a valve to control recirculating a sample passed the binding sites multiple times, principally to improve signal strength. The incorporation of valves into the microfluidic device adds complexity and cost.

United States patent application No. 2004/0248306, assigned to Hewlett-Packard Company, describes an essentially passive microfluidic device. The Hewlett-Packard device relies entirely on capillary action to move fluid samples through the device. In order for capillary action to be effective an air management chamber is required. Reliance on capillary action severely limits the versatility and effectiveness of the device.

Another interesting application of microchannel technology is found in international application number WO 1999/49319, by Streen Ostergard and Gert Blankenstein. Their device is a ‘non-flow’ microchannel system that uses fields to move particles between active zones. One example is to interact a sample with a reagent bonded to magnetic beads and to use magnetic fields to move the beads through the channels, and hence through buffers and reagents.

Notwithstanding the variety of microfluidic devices that are available there is a need for a device in which all necessary processing steps to analyse a sample can be performed without user intervention after the sample has been introduced to the device.

### OBJECT OF THE INVENTION

It is an object of the present invention to provide a closed loop microfluidic device.

Further objects will be evident from the following description.

### DISCLOSURE OF THE INVENTION

In one form, although it need not be the only or indeed the broadest form, the invention resides in a closed loop microfluidic device comprising:

a body;

at least one microchannel formed in the body, said microchannel forming a closed loop;

at least one sealable input port for delivering a sample into said at least one microchannel; and

at least one pump in fluid connection with said at least one microchannel, said pump receiving an external motive force.

Preferably the device further comprises at least one capture zone located within the body and in fluid connection with said at least one microchannel.

The device preferably also includes at least one detection zone located within the body and in fluid connection with said at least one microchannel. The detection zone and the capture zone may suitably be a single zone performing both functions.

There may be at least one reagent contained in a chamber within the body and movable through the at least one microchannel under influence of the pump.

Suitably the pump is a ferrofluidic pump and the external motive force is a magnetic field. The pump applies force to pull and push fluid through the microchannels.

The device preferably has a plurality of microchannels connecting said sealable input port with one or more chambers and one or more zones.

In a further form the invention resides in a method of processing a sample in a closed loop microfluidic device including the steps of:

drawing a metered amount of said sample through an input port into a microchannel formed in a body of the device, said microchannel forming a closed loop;

sealing the input port to close the device; and

applying an external motive force to a pump to move the sample from the input port to at least one active zone, said pump applying force to pull and push the sample through the microchannel.

### BRIEF DETAILS OF THE DRAWINGS

To assist in understanding the invention preferred embodiments will now be described with reference to the following figures in which:

FIG. 1 is a schematic displaying the principle of operation of a closed loop microfluidic device;

FIG. 2 is a schematic displaying introduction of a sample to a first embodiment of a closed loop microfluidic device incorporating a zone;

FIG. 3 shows the movement of the sample to the zone;

FIG. 4 shows the movement of the sample past the zone;

FIG. 5 shows a reagent contained in the device;

FIG. 6 shows the movement of a reagent past the zone;

FIG. 7 is a schematic of a second embodiment of a closed loop microfluidic device;

FIG. 8 is a cross-sectional schematic view of the embodiment taken through AA in FIG. 7;

FIG. 9 shows the view of FIG. 8 with a pre-deformed pressure structure;

FIG. 10 shows the embodiment of FIG. 9 loading a sample;

FIG. 11 shows a third embodiment of a closed loop microfluidic device having two microchannel loops;

FIG. 12 shows fluid samples being moved around the device of FIG. 11 under the influence of a first pump;

FIG. 13 shows fluid samples being moved around the device of FIG. 11 under the influence of a second pump;

FIG. 14 shows fluid samples being moved around the device of FIG. 11 under the influence of a first pump again;

FIG. 15 shows a sketch of a bioassay chip;

FIG. 16 shows a detailed schematic of one embodiment of a bioassay chip;

FIG. 17 shows an image of a bioassay chip reader;

FIG. 18 shows a schematic of the operation of the bioassay chip reader;

FIG. 19 shows a first step in the operation of the bioassay chip of FIG. 16;

FIG. 20 shows a second step in the operation of the chip of FIG. 16;

FIG. 21 shows a third step in the operation of the chip of FIG. 16;

FIG. 22 shows a fourth step in the operation of the chip of FIG. 16;

FIG. 23 shows a fifth step in the operation of the chip of FIG. 16;

FIG. 24 shows a first step in the operation of a second embodiment of a bioassay chip;

FIG. 25 shows a second step in the operation of the chip of FIG. 24; and

FIG. 26 shows a third step in the operation of the chip of FIG. 24.

### DETAILED DESCRIPTION OF THE DRAWINGS

In describing different embodiments of the present invention common reference numerals are used to describe like features.

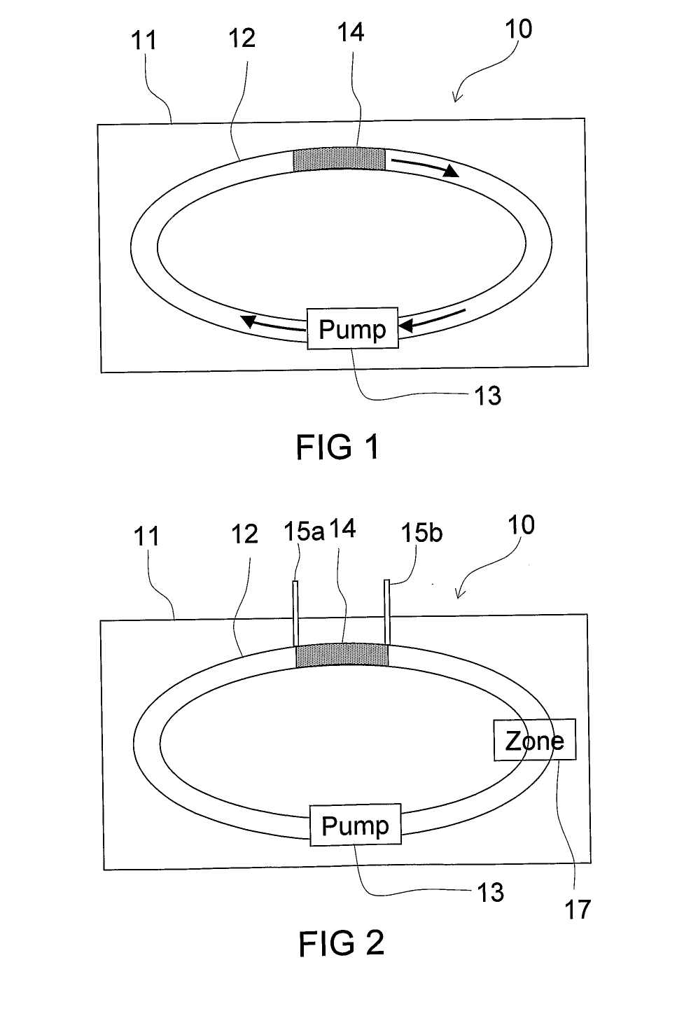

Referring to FIG. 1 there is shown a schematic of a microfluidic device 10 comprising a body 11 and a closed loop microchannel 12. A pump 13 moves a fluid sample 14 around the loop. Because the microchannel is a closed loop the pump both pushes and pulls the sample, as indicated by the arrows.

The pump 13 may be selected from a variety of suitable pumps. The preferred pump is a ferrofluidic pump that uses a magnetic field to move a ferromagnetic slug through the microchannel. Other suitable pumps include a peristaltic pump, a syringe piston, microcantilevers and microrotor impellors.

As depicted in FIG. 2, the fluid sample 14 can be introduced to the microchannel 12 through sample input port 15 comprising injection ports 15a, 15b while the pump 13 is stopped. The inactive pump prevents movement of the sample fluid through the microchannel except between the injection ports 15a, 15b. Injection of the fluid sample into one port, say 15a, displaces air from the microchannel through the other injection port 15b. This arrangement allows a metered amount of fluid sample to be introduced to the microfluidic device since the volume of introduced sample can be no more than the volume of the microchannel between the injection ports 15a, 15b.

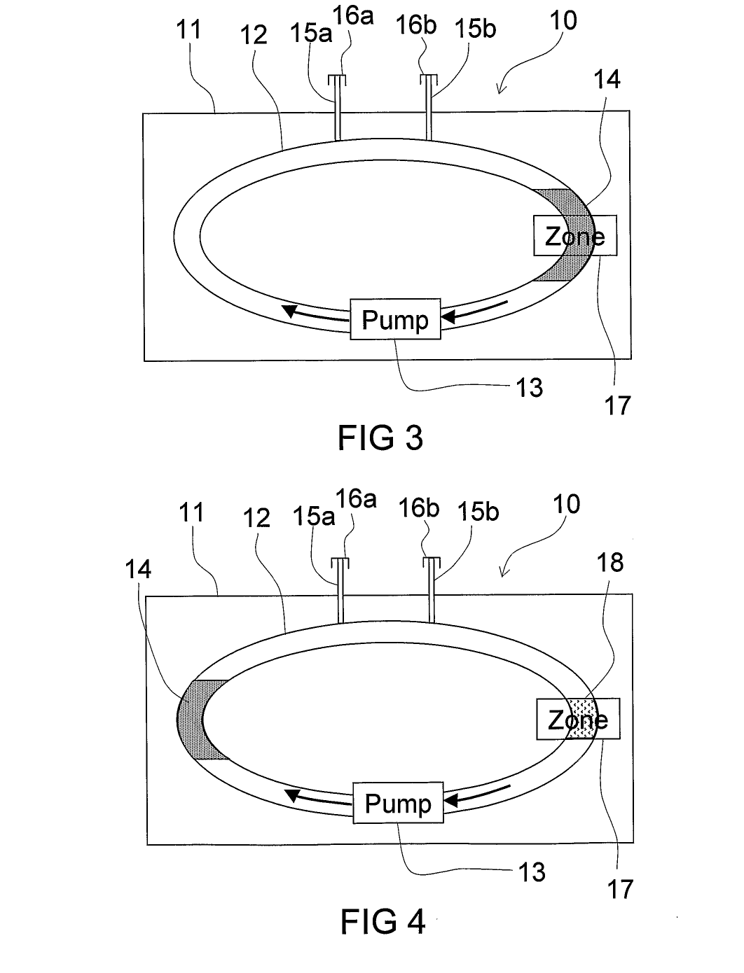

Once the fluid sample 14 has been loaded into the microchannel 12 the injection ports 15a, 15b are sealed, for example by caps 16a, 16b, as shown in FIG. 3. The pump 13 is activated to move the sample 14 through the microchannel, for example, to an active zone 17.

It will be appreciated that once the injection ports 15a, 15b are sealed with caps 16a, 16b the device is completely closed. This has particular benefit if the device is being used to conduct an assay on a carcinogenic or pathogenic sample. However, the device need not be used for this purpose. It may be particularly useful for long term storage of biological samples. Once the sample is introduced to the microfluidic device it can be kept free from contamination for an extended period of time. The preferred embodiment of the device is constructed from medical grade plastics which can be stored at or near absolute zero and under vacuum. The inventors believe the device is very useful for long term storage of biological samples, such as blood.

As mentioned above, the preferred embodiment of FIG. 2 includes an active zone 17 which in one embodiment may be a storage zone. For long term storage the sample 14 may remain at the zone 17 but it is usually preferable that the pump 13 continue to move the sample 14 past the zone 17, as shown in FIG. 4, leaving the components of interest 18 at the zone 17. In this case the zone 17 is considered to be a capture zone for capturing and retaining components of interest 18 from the sample 14. These components of interest 18 can be stored for an indefinite period in the closed microfluidic device.

The embodiment of FIGS. 2-4 allow samples to be stored for extended periods of time and for components of interest to be extracted from samples and stored. The inventors believe the device will find application in storing blood, extracting blood components for storage, and storing natural and synthetic extracts. The sample may contain nucleic acids which can be trapped and protected from degradation for later analysis, such as genotyping, identification or forensic analysis. The device is particularly useful for long term storage of genetic evidence used in criminal cases.

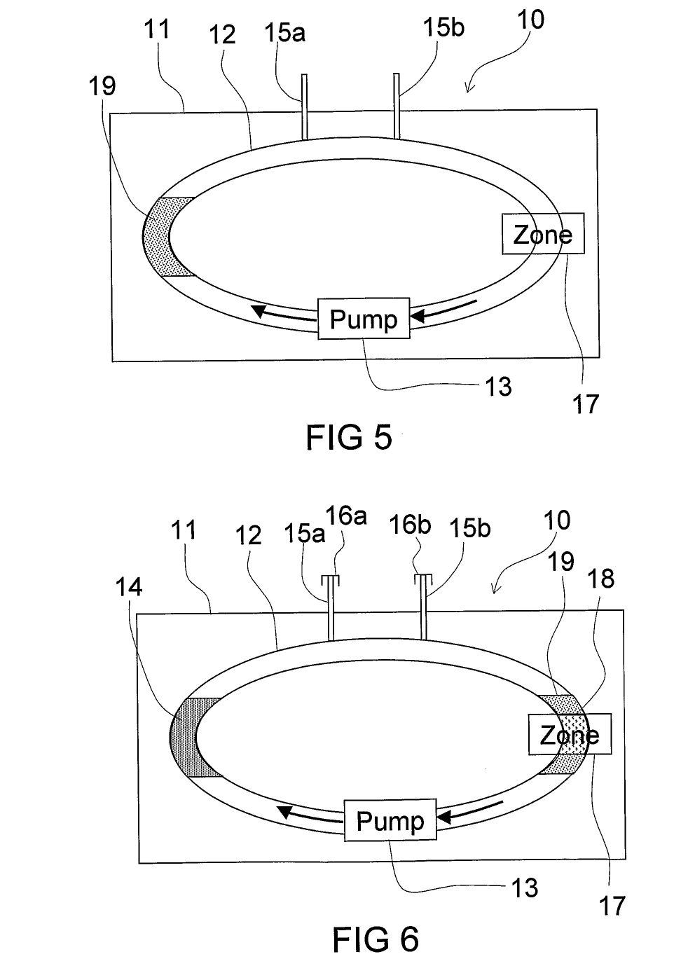

In many applications it will be desirable to treat the sample with on-board reagents in the microfluidic device 10. The embodiment of FIG. 5 demonstrates that reagent 19 can be located in the microchannel 12 prior to introduction of the sample 14. As is clear from the earlier discussion, the sample 14 can be introduced through injection ports 15a, 15b without disturbing the reagent 19 while the pump 13 is stopped and locked into position. Once the injection ports 15a, 15b are sealed and the pump 13 is activated the sample 14 is moved through the microchannel 12. The reagent 19 is also moved through the microchannel 12 at the same rate. As shown in FIG. 6, the components of interest 18 are trapped in the zone 17 and washed by reagent 19. Continued operation of the pump 13 will move the reagent 19 past the components of interest 18 to a position near the pump 13 and will move the sample 14 to a position near the injection ports 15a, 15b.

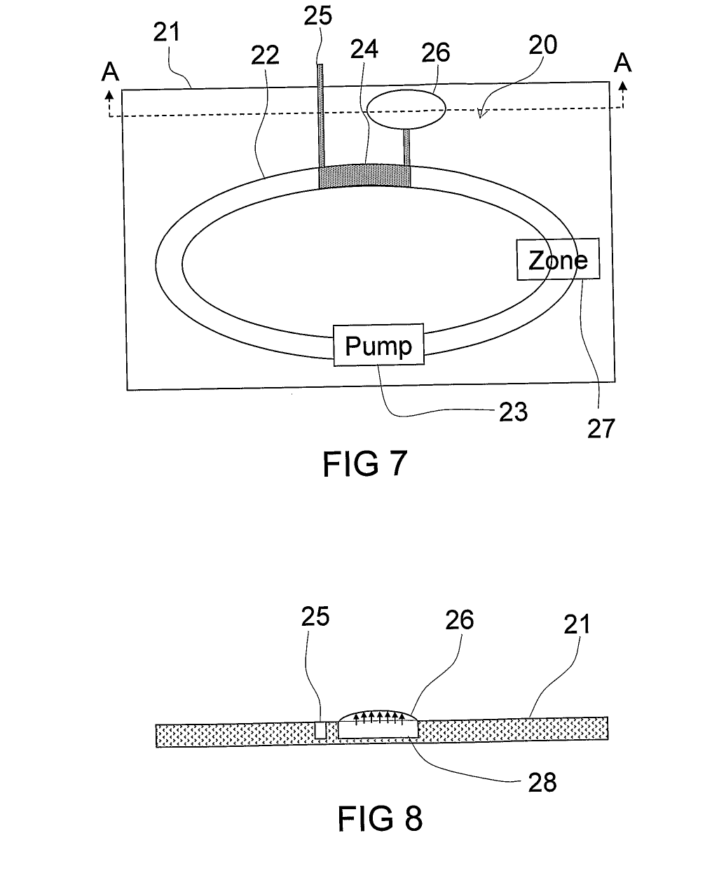

FIG. 7 shows a second embodiment of a microfluidic device 20 comprising a body 21 and a closed loop microchannel 22. A pump 23 moves a fluid sample 24 around the loop 22 past zone 27.

The fluid sample 24 is introduced to the microchannel 22 through sample injection port 25 while the pump 23 is stopped. As fluid is injected into the port 25 the pressure is absorbed by pressure containment structure 26. The pressure containment structure may take various forms but one appropriate form is a deformable diaphragm sealed over a cavity 28 formed in the body 21, as seen most clearly in FIG. 8.

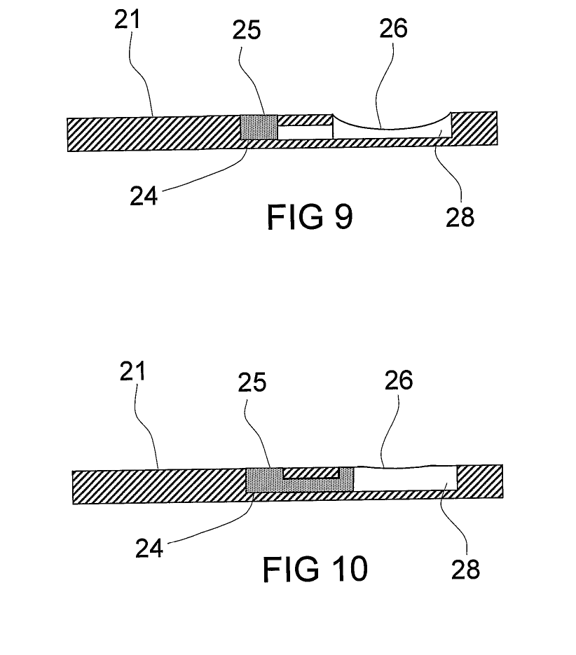

In the embodiment of FIG. 7 the sample 24 is injected into the microchannel 22 while the pressure containment structure deforms. FIG. 9 shows a modified embodiment in which the pressure containment structure 26 is pre-deformed and can be used as an aspiration mechanism. The user fills the injection port 25 and the structure 26 is released (manually or automatically) to draw a sample 24 into the cavity 28 as shown in FIG. 10.

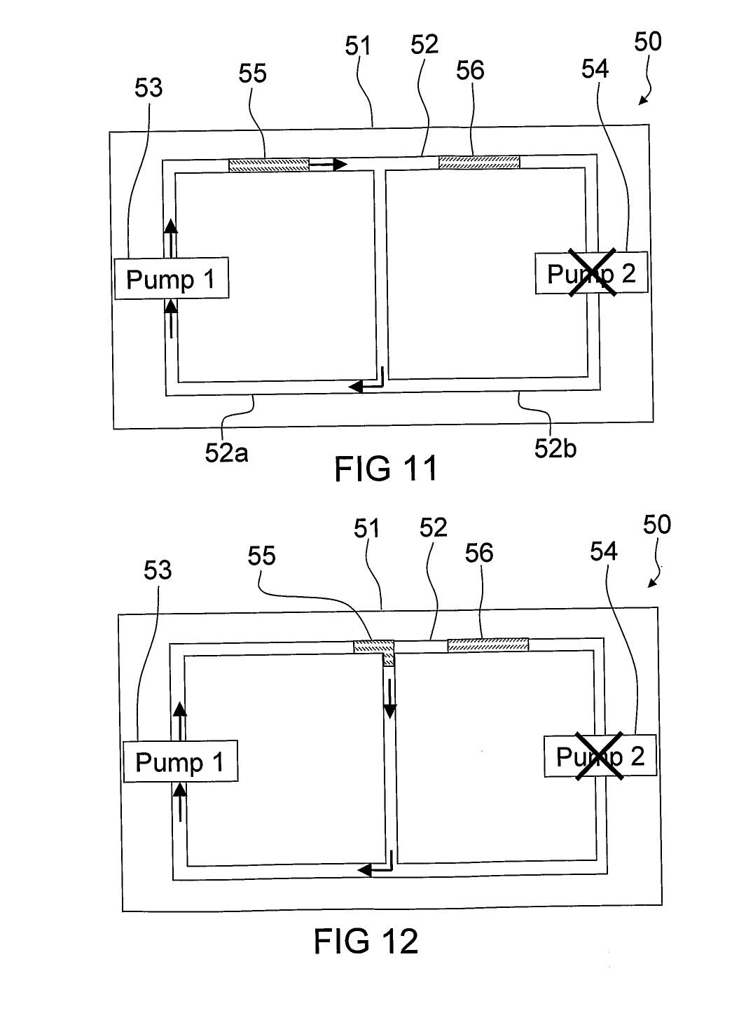

The general principle of operation disclosed in FIG. 1-10 can be applied to more complex structures. FIG. 11 shows an embodiment of a microfluidic device 50 comprising a double loop microchannel 52 having a first loop 52a with pump 53 and second loop 52b with pump 54. A first fluid slug 55 is located in the first loop 52a and a second fluid slug 56 is located in the second loop 52b. The fluid slugs may be samples introduced by one of the methods described above or may be reagents pre-located to the loop.

When the second pump 54 is stopped and the first pump 53 is activated the first fluid slug 55 is propelled through loop 52a as shown by the arrows. The slug 55 will move around the loop as shown in FIG. 12. It will not move into the second loop 52b since the pump 53 generates a higher pressure behind the slug 55 and a lower pressure in front compared to the pressure in the second loop 52b.

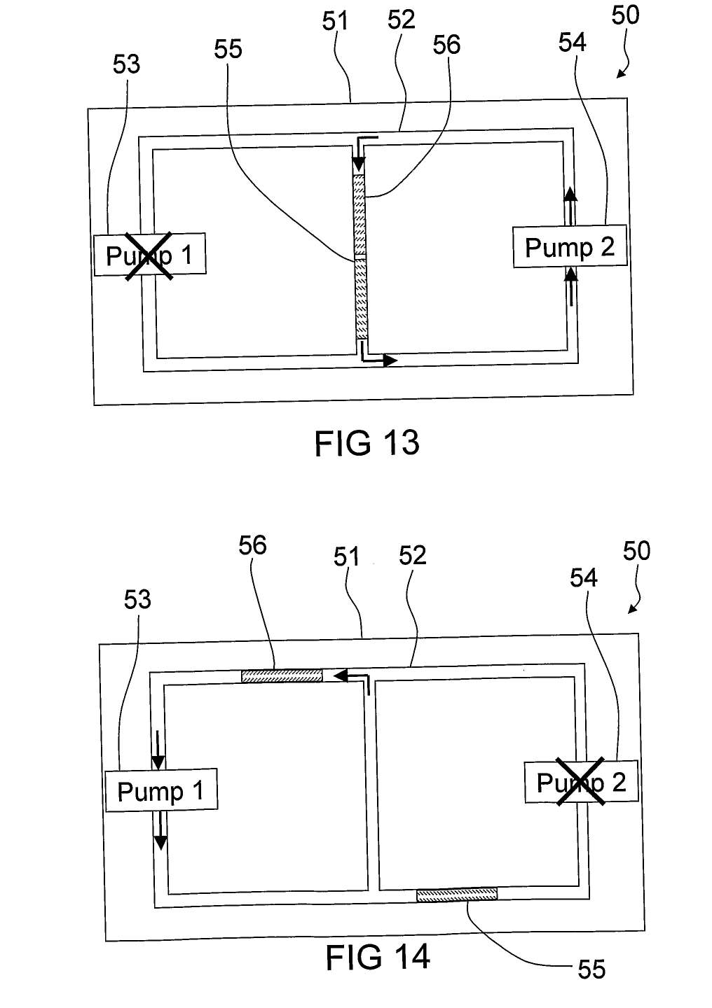

As shown in FIG. 13, the second fluid slug 56 can be moved around the loop 52b by turning off first pump 53 and activating second pump 54. It will be appreciated that either pump can move the fluid slugs through the common microchannel between the loops. Once the first fluid slug 55 has moved into second loop 52b the second pump 54 can be stopped and the first pump 53 reactivated, but in the reverse direction. This will propel fluid slug 56 into first loop 52a, as depicted in FIG. 14.

The series of operations shown in FIGS. 11-14 demonstrate how the closed loop microfluidic device is used to manipulate fluid samples without any moving part (in the case of ferrofluidic pumping) or mechanical valve. Complex devices may be constructed (which will all fall within the scope of the invention) to move fluid samples and reagents for capture, complex processing and analysis.

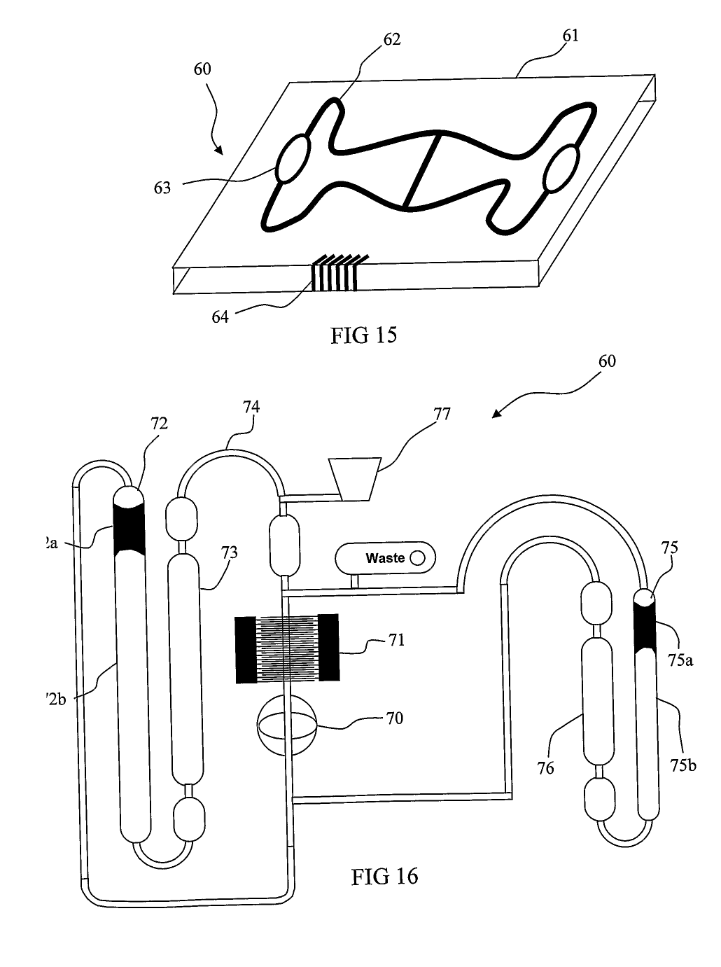

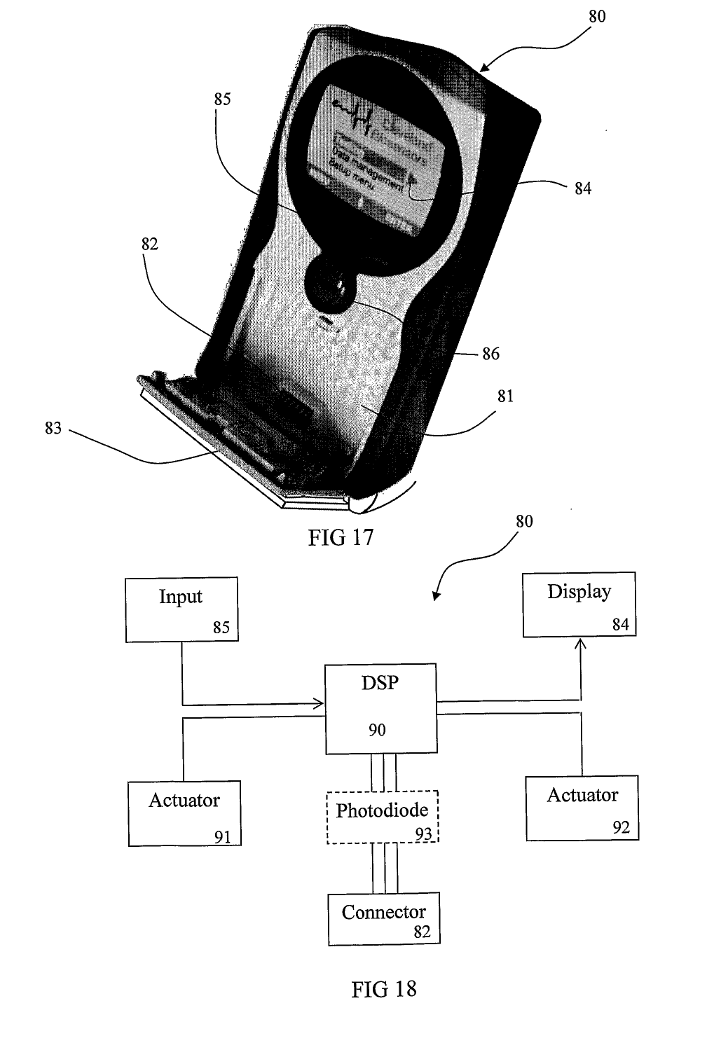

A complex bioassay chip with chambers is shown schematically in FIG. 15. The bioassay chip is generally designated as 60 and consists of a plastic body 61 in which a number of channels 62 and chambers 63 are formed. The purpose of each channel and chamber is described in greater detail below by reference to the operation of the chip 60 in conjunction with a chip reader 80, shown in FIG. 17. In some embodiments a connector 64 carries electrical signals between the chip 60 and the reader 80.

A detailed schematic of the layout of one embodiment of the bioassay chip is shown in FIG. 16. In this embodiment the chip is configured for analyzing a small chemical or biological sample to detect one or more target substances. The chip is configured to include a magnetic capture zone 70 and an electro-active detection zone 71, which in this embodiment is an arrangement of electrodes to detect signals from charged particles released from the capture zone. A first ferrofluidic pump 72 moves solution from a first chamber 73 through various channels, such as 74. A second ferrofluidic pump 75 moves another solution from a second chamber 76 through the channels. Sample is introduced to the chip 60 at port 77.

The bioassay chip incorporates a number of passive stop structures allowing the containment of reagents in individual chambers. In general terms, a minimum cross-sectional dimension of the stop structure is sufficiently smaller than a minimum cross-sectional dimension of the second channel so that differential capillary forces prevent wicking of fluid from the first channel, through the stop structure, and into the second channel when there is no fluid in the second channel.

As is known in the prior art, the ferrofluidic pumps are formed by drops of ferrofluid that are moved under the influence of a magnetic field. In the preferred embodiment magnetic oil drops 72a, 75a move in chambers 72b, 75b under the influence of an applied field, such as generated by a moving magnet.

The chip 60 is described in more detail below with reference to a particular application. As described above, the chip 60 operates as a closed system. Once the sample is introduced to the chip 60 there is no external contact to the sample. The ferrofluidic pumps operate to move the sample and solutions around the chip and signals are collected via the connector.

The chip reader 80 has a compartment 81 that receives the chip 70. The connectors 64 align with corresponding connectors 82 in the reader. When the door 83 is closed a menu of available tests is available in display 84 and can be selected using buttons 85. When the test is complete the spent chip 60 is ejected by pushing button 86. The inventors anticipate that the chips 60 will be disposable although reusable chips are envisaged.

FIG. 18 shows a schematic block diagram of the functional elements of the chip reader 80. Central to the reader is a digital signal processor or other processing element 90. All control and analysis processes are performed in this element. Although shown as a single element persons skilled in the art will appreciate that the functionality will normally be provided by a number of integrated circuits and discrete elements. A pair of actuators 91, 92 provides the motive forces to move the oil drops 72a, 75a along the chambers 72b, 75b. In one simple embodiment the actuators are magnets moved linearly under the assay chip 60. A magnetic field may also be produced electronically. Motions more sophisticated than a simple linear motion are envisaged. Signals from the detection zone 71 are passed to the DSP 90 via connectors 64 and 82. The result of the test is available at display 84. The reader may also have an external access port (not shown) for connection to a computer for more detailed off-line analysis.

As mentioned above, the reader and chip are not limited to any particular detection method. The reader may include other optional detection devices, such as a photodiode 93. In such an embodiment signals are read directly by the reader and there is no requirement for connectors 64, 82.

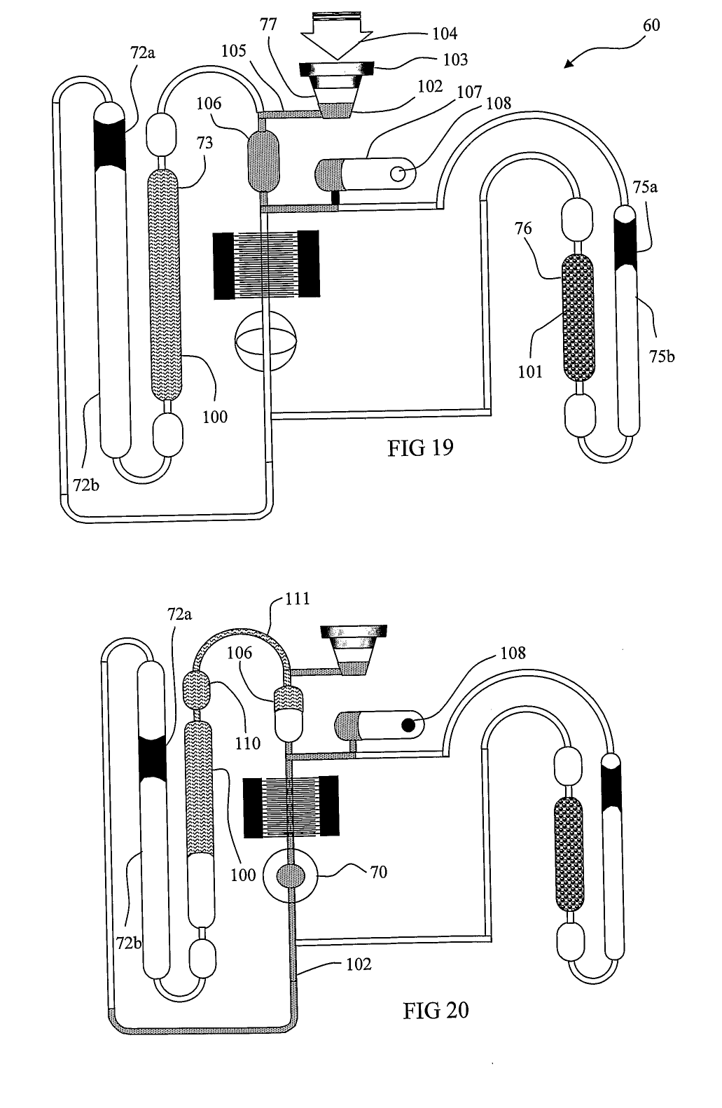

To better understand the operation of the assay chip 60 a specific example is described with reference to the chip layout shown in FIGS. 19-23. The chip 60 is initially charged with a buffer solution 100 in buffer chamber 73 and a detergent solution 101 in detergent chamber 76. Oil drops 72a, 75a are contained in pump chambers 72b, 75b respectively.

In use, a test is selected from the menu of tests in the reader. A sample 102 is prepared by mixing for a few minutes in a test vial with a reporter species and magnetic beads, both coated with chemical or biological receptors able to recognize and capture the analyte in the sample. The analyte is trapped between magnetic beads and the reporter species. Suitable reporter species include but are not restricted to dendrimers, latex beads, liposomes, colloidal gold, fluorescent materials, visible materials, bio- and chemiluminescent materials, enzymes, nucleic acids, peptides, proteins, antibodies and aptamers. The receptors can be biological cells, proteins, antibodies, peptides, antigens, nucleic acids, aptamers, enzymes, or other biological receptors as well as chemical receptors.

In a preferred embodiment, the reporter species is a liposome filled with a large number of marker molecules so that each analyte molecule is now indirectly carrying a large number of marker molecules, which after lysis of the liposomes with a lysing agent, will be released resulting in a direct signal amplification. Suitable markers entrapped in the liposomes include fluorescent dyes, visible dyes, bio- and chemiluminescent materials, enzymatic substrates, enzymes, radioactive materials and electroactive materials. Suitable lysing agents include surfactants such as octylglucopyranoside, sodium dodecylsulfate, sodium dioxycholate, Tween-20, and Triton X-100. Alternatively, complement lysis can be employed.

It will be appreciated that other capture systems than magnetics beads can be used and that the specific preparation will depend on the nature of the test and the nature of the sample. The invention is not limited to any particular test configuration and includes direct and indirect competitive and non-competitive assays. Furthermore, the invention is not limited to any particular test or combination of tests. The inventors envisage that the range of available tests will grow over time. However, for the purposes of this explanation a specific sample preparation will be assumed.

The sample 102 is added to port 77 as shown in FIG. 19. A cap 103 is applied and pressed 104 so as to force sample 102 through channel 105 to fill sample chamber 106. Excess sample fills waste chamber 107 displacing air through vent 108. The vent 108 is closed and the sealed assay chip 60 is placed in the reader 80.

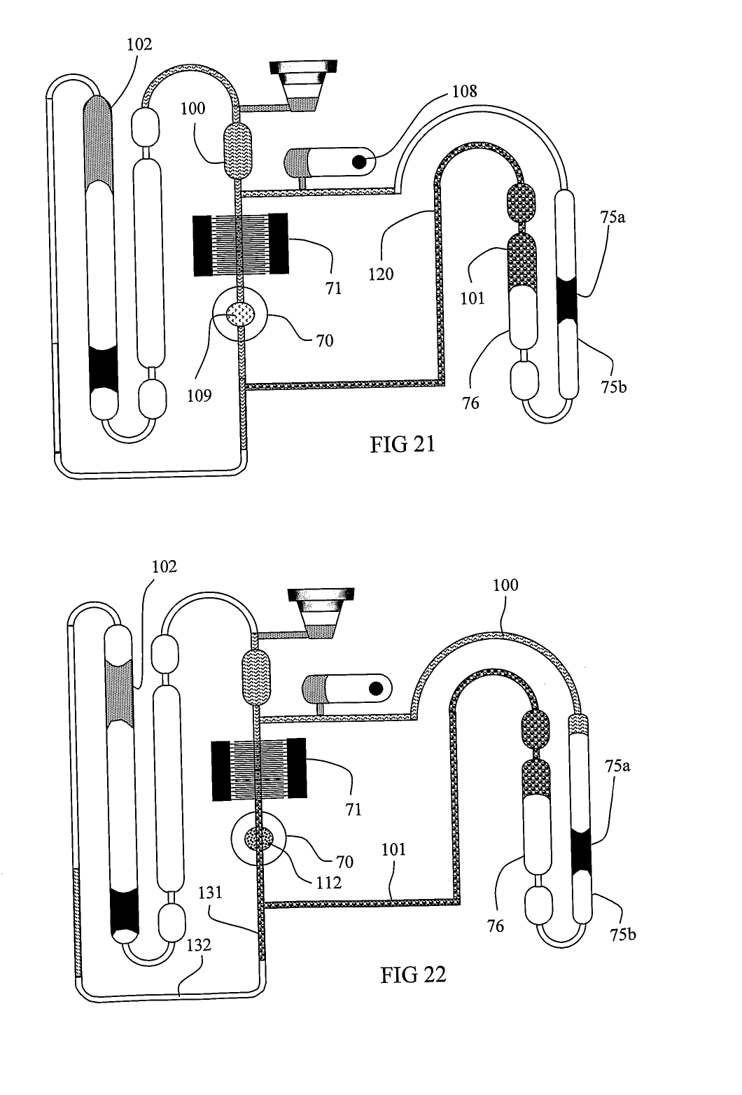

Magnetic actuator 91 in the reader 80 is activated to propel oil drop 72a through chamber 72b thus forcing buffer solution 100 into passive stop structure 110 and through channel 111, as depicted in FIG. 20. The buffer solution floods the sample chamber 106 and forces sample 102 towards magnetic capture zone 70. The beads and liposome particles 109 are captured in the magnetic capture zone 70 and washed by buffer solution 100, as shown in FIG. 21. The buffer solution washes away any loosely bound particles and therefore ensures a low background signal.

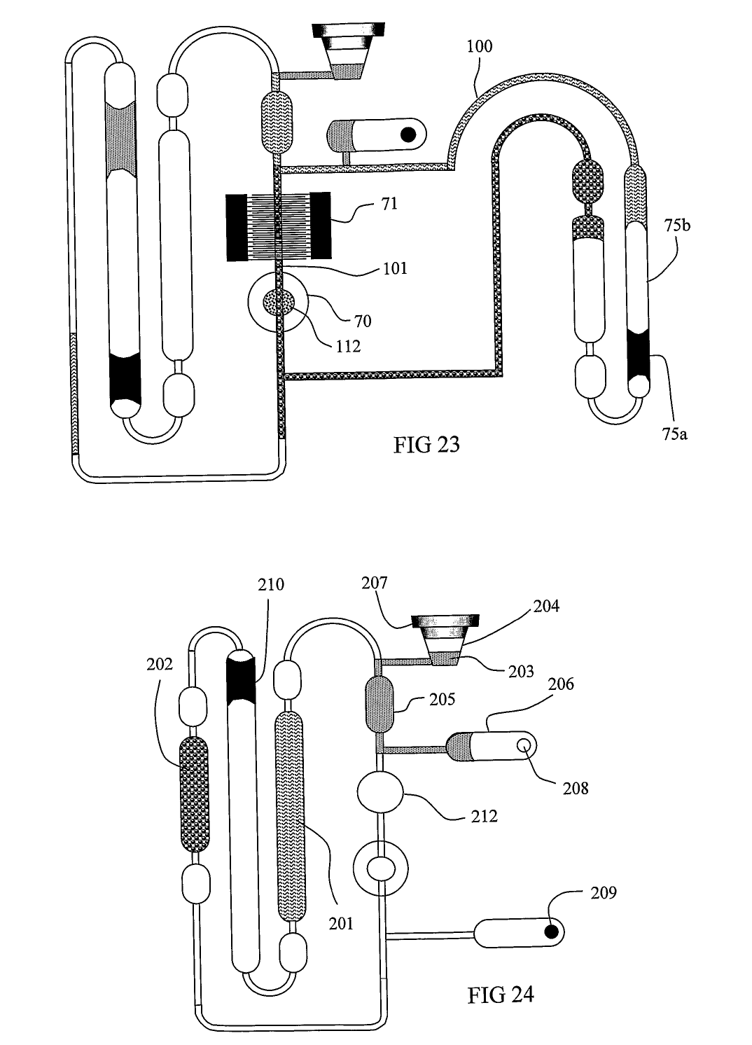

While the first magnetic actuator is still active, the second magnetic actuator 92 in the reader 80 is activated to drive oil drop 75a along chamber 75b, thus forcing detergent solution 101 from chamber 76 into channel 120 (FIG. 21). When channel 120 is filled with detergent, magnetic actuator 91 is stopped. Detergent 101 consequently flows towards zone 70. When the detergent 101 reaches the magnetic capture zone 70 the detergent bursts the liposomes (FIG. 22). Electro-active charged particles 112 flood back over the electrodes 71 and a diagnostic signal is generated (FIG. 23). The signal is received by the DSP 90 in the reader 80 via connector 64 and connector 82.

The timing of the operation of the ferrofluidic pumps 72, 75 is important to the operation of the assay chip. The second pump 75 is started just before the end of the stroke of the first pump 72. This ensures that the risk of introducing air bubbles is reduced. The detergent enters channel 131 while pump 72 is still operating and thus some detergent flows behind the buffer and traps an air bubble 132, as seen in FIG. 22. When pump 72 is stopped, the continued operation of pump 75 forces the detergent 101 across the capture zone 70.

The detector 71 is designed to suit the particular test being performed in the assay chip 60. In the preferred embodiment the detector is an electrode array having interleaved (interdigitated) electrodes designed to maximize the detected signal and the reporter species is a liposome entrapping an electroactive marker.

Although the preferred embodiment employs two ferrofluidic pumps it will be appreciated that the invention is not so limited. FIG. 24 is a sketch of a chip 200 employing a single ferrofluidic pump 210. Furthermore, the chip is not limited to detecting electro-active substances. The embodiment of FIG. 24 employs a photodetection technique wherein a photoactive sample is detected by a photodiode 93 in the reader as it passes a window 212.

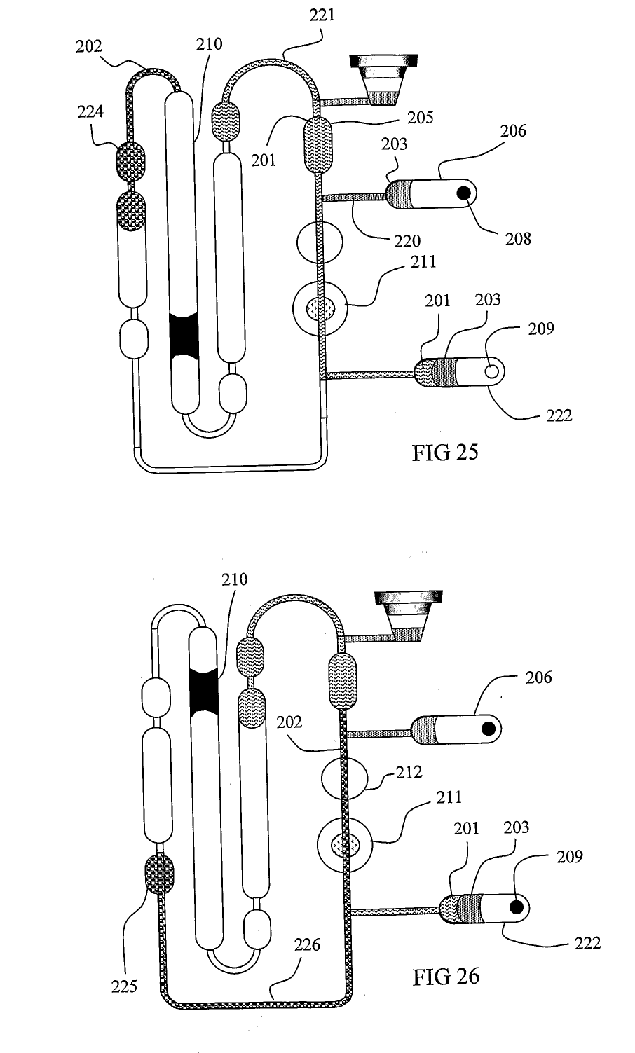

As with the first embodiment, the chip is pre-loaded with buffer 201 and reagent 202. A sample 203 is prepared and introduced to port 204. The sample fills bubble trap 205 with excess sample going to waste chamber 206 as pressure is applied by cap 207. Vent 208 is closed and vent 209 is opened, as shown in FIG. 25. Ferrofluidic pump 210 is activated to pump buffer 201 through channel 221 thus forcing sample 203 across capture zone 211 and into waste chamber 222, as shown in FIG. 25. At the same time, reagent 202 is drawn into stop structure 224.

The channels, such as 220, are sufficiently small that there is appreciable surface tension. Thus the sample 203 and buffer 201 flow into waste chamber 222 as long as vent 209 is open.

The vent 209 is closed once buffer 201 reaches waste chamber 222. Ferrofluidic pump 210 is reversed so that it forces reagent 202 through bubble trap 225 and channel 226 to capture zone 211. The reagent 202 reacts with particles at the capture zone 211 to generate chemiluminescence that is detected through window 212.

Other ferrofluidic pump designs are anticipated to be required for specific applications.

Application of the microfluidic device for electro-detection and photo-detection systems have been described. It will be appreciated that the invention is not limited to any particular detection system, in fact as described earlier, the device may be used for storage only with no detection system. It will also be appreciated that the invention is not limited to a particular number or configuration of microchannels. Although embodiments have been described with one or two microchannel loops it will be clear to persons skilled in the field that the invention can be extended to multiple loops in fluid connection to varying degrees.

Throughout the specification the aim has been to describe the preferred embodiments of the invention without limiting the invention to any one embodiment or specific collection of features.

1. A closed loop microfluidic device comprising:
a body;
at least one microchannel formed in the body, the microchannel forming a closed loop;
at least one sealable input port for delivering a sample into the at least one microchannel; and
at least one ferrofluidic pump in fluid connection with the at least one microchannel, the pump receiving a magnetic field as an external motive force.

2. The closed loop microfluidic device of claim 1 further comprising one or more active zones located within the body and in fluid connection with the at least one microchannel.

3. The closed loop microfluidic device of claim 2 wherein at least one of the one or more active zones comprises a storage zone adapted to store the sample.

4. The closed loop microfluidic device of claim 2 wherein at least one of the one or more active zones comprises a capture zone adapted to capture the sample or one or more components of the sample.

5. The closed loop microfluidic device of claim 2 wherein at least one of the one or more active zones comprises a detection zone adapted to detect one or more components of the sample.

6. (canceled)

7. The closed loop microfluidic device of claim 1 further comprising one or more chambers located within the body and in fluid connection with the at least one microchannel.

8. The closed loop microfluidic device of claim 7 wherein at least one of the one or more chambers contains at least one reagent movable through the at least one microchannel under influence of the pump.

9. (canceled)

10. The closed loop microfluidic device of claim 1 wherein the sealable input port delivers a metered amount of sample to the at least one microchannel

11. The closed loop microfluidic device of claim 1 further comprising an aspiration mechanism fluidly connected to the sealable input that draws the sample into the at least one microchannel.

12. The closed loop microfluidic device of claim 1 further comprising one or more sealable waste ports.

13. The closed loop microfluidic device of claim 2 wherein at least one of the one or more active zones is an electrode that detects signals from the sample.

14. The closed loop microfluidic device of claim 2 wherein at least one of the one or more active zones is a magnetic capture zone.

15. The closed loop microfluidic device of claim 1 further comprising data transfer means.

16. The closed loop microfluidic device of claim 2 wherein at least one of the one or more active zones is a photodetection zone that detects signals from photoactive particles from the sample.

17. (canceled)

18. A closed loop microfluidic device comprising:
a body;
at least one microchannel formed in the body, the microchannel forming a closed loop;
at least one sealable input port for delivering a sample into the at least one microchannel;
at least one pump in fluid connection with the at least one microchannel, said pump receiving an external motive force; and
a pressure containment structure, fluidly connected to the sealable input port, which absorbs pressure as the sample is delivered to said the at least one microchannel.

19. The closed loop microfluidic device of claim 18 further comprising one or more active zones located within the body and in fluid connection with the at least one microchannel.

20. The closed loop microfluidic device of claim 19 wherein at least one of the one or more active zones comprises a storage zone adapted to store the sample.

21. The closed loop microfluidic device of claim 19 wherein at least one of the one or more active zones comprises a capture zone adapted to capture the sample or one or more components of the sample.

22. The closed loop microfluidic device of claim 19 wherein at least one of the one or more active zones comprises a detection zone adapted to detect one or more components of the sample.

23. (canceled)

24. The closed loop microfluidic, device of claim 18 further comprising one or more chambers located within the body and in fluid connection with the at least one microchannel.

25. The closed loop microfluidic device of claim 24 wherein at least one of the one or more chambers contains at least one reagent movable through the at least one microchannel under influence of the pump.

26. (canceled)

27. The closed loop microfluidic device of claim 18 wherein the sealable input port delivers a metered amount of sample to the at least one microchannel.

28. The closed loop microfluidic device of claim 18 further comprising an aspiration mechanism fluidly connected to the sealable input that draws the sample into the at least one microchannel.

29. The closed loop microfluidic device of claim 18 further comprising one or more sealable waste ports.

30. The closed loop microfluidic device of claim 19 wherein at least one of the one or more active zones is an electrode that detects signals from the sample.

31. The closed loop microfluidic device of claim 19 wherein at least one of the one or more active zones is a magnetic capture zone.

32. The closed loop microfluidic device of claim 18 further comprising data transfer means.

33. The closed loop microfluidic device of claim 19 wherein at least one of the one or more active zones is a photodetection zone that detects signals from photoactive particles from the sample.

34. (canceled)

35. A closed loop microfluidic device comprising:
a body;
a first microchannel formed in the body, the microchannel forming a closed loop;
a second microchannel formed in the body and in fluid connection with the first channel, the second microchannel forming a closed loop;
at least one sealable input port for delivering a sample into one of the first microchannel or the second microchannel;
a first pump in fluid connection with the first microchannel, wherein when active the first pump receives an external motive force to move fluid through the first microchannel, and when inactive the first pump prevents fluid movement through the first microchannel; and
a second pump in fluid connection with the second microchannel, wherein when active the second pump receives an external motive force to move fluid through the second microchannel, and when inactive the second pump prevents fluid movement through the second microchannel.

36. The closed loop microfluidic device of claim 35 wherein the first microchannel and the second microchannel have a common channel portion.

37. The closed loop microfluidic device of claim 35 comprising a storage chamber in at least one of the first microchannel and the second microchannel.

38. (canceled)

39. The closed loop microfluidic device of claim 36 comprising a capture zone in the common channel portion.

40. The closed loop microfluidic device of claim 36 comprising a magnetic capture zone in the common channel portion.

41. The closed loop microfluidic device of claim 36 comprising a detection zone in the common channel portion.

42. (canceled)

43. The closed loop microfluidic device of claim 35 wherein the first pump and the second pump are ferrofluidic pumps.

44. The closed loop microfluidic device of claim 35 further comprising:
at least one sealable input port for delivering a sample into the first or second microchannel; and
a pressure containment structure, fluidly connected to the sealable input port, which absorbs pressure as the sample is delivered to the first microchannel or the second microchannel.

45. (canceled)

46. A method of processing a sample in a closed loop microfluidic device by:
drawing a metered amount of the sample through an input port into a microchannel formed in a body of the device, the microchannel forming a closed loop;
sealing the input port to close the device; and
applying an external motive force to a pump to move the sample from the input port to at least one active zone, the pump applying force to pull and push the sample through the microchannel.
